(19) United States
(12) Patent Application Publication
(10) Pub. No.: US 2009/0183245 A1
(43) Pub. Date: Jul. 16, 2009

(54) Limited Functionality Mode for Secure, Remote, Decoupled Computer Ownership

(76) Inventors: Gary H. Simpson, Framingham, MA (US); Geoffrey Strongin, Austin, TX (US); Andrew R. Rawson, Austin, TX (US); Garth D. Hillman, Lakeway, TX (US); Ralf Findeisen, Dresden (DE)

Correspondence Address: MEYERTONS, HOOD, KIVLIN, KOWERT & GOETZEL (AMD), P.O. BOX 398, AUSTIN, TX, 78767-0398, US

(21) Appl. No.: 11/972,351

(22) Filed: Jan. 10, 2008

(51) Int. Cl. H04L 9/32

(52) U.S. Cl. 726/7

(57) ABSTRACT

In one embodiment, a computer system comprises one or more components and a secure computing environment coupled to the components. The secure computing environment is configured to program at least one of the components to enter a limited functionality mode responsive to expiration of a use right to the computer system, wherein operation of the computer system in the limited functionality mode is reduced compared to operation when the use right has not expired. The secure computing environment is configured to monitor the components in the limited functionality mode to detect that a limited functionality mode configuration has been modified by an unauthorized entity and to cause the computer system to enter a second mode in which operation of the computer system is reduced compared to operation in the limited functionality mode in response. In another embodiment, the secure computing environment detects a non-temporal event that indicates a violation of an owner-imposed restriction and enters a limited functionality mode.

### BACKGROUND

1. Field of the Invention

This invention is related to the field of computer systems and, more particularly, to conveying use rights for a computer system to non-owners of the computer system.

2. Description of the Related Art

Computer systems used by individual users have generally been sold to the users for an up-front sales price. The user takes possession of the computer system, becoming the owner. While this sales mechanism has served the industry and its customers well thus far, the continued penetration of computer systems into lower income households (and even entire countries where penetration is low) is hampered by the large up-front investment that must be made by the user. To avoid the up-front investment for the user, a lease business model is envisioned in which the user may purchase a use right to the computer system. The use right may periodically expire (e.g. after a given amount of calendar time or a given amount of computer system on time) and the user may renew the lease/use right with an additional payment.

### SUMMARY

In one embodiment, a computer system comprises one or more components and a secure computing environment coupled to the components. The secure computing environment is configured to program at least one of the components to enter a limited functionality mode responsive to expiration of a use right to the computer system, wherein operation of the computer system in the limited functionality mode is reduced compared to operation when the use right has not expired. The secure computing environment is configured to monitor the components in the limited functionality mode to detect that a limited functionality mode configuration has been modified by an unauthorized entity and to cause the computer system to enter a second mode in which operation of the computer system is reduced compared to operation in the limited functionality mode in response. A method and computer readable storage medium storing code that implements the method are also contemplated.

In another embodiment, a computer system comprises one or more components and a secure computing environment coupled to the components. The secure computing environment is configured to detect a non-temporal event that indicates a violation of a restriction imposed by an owner of the computer system. Additionally, the secure computing environment is configured to program at least one of the components to enter a limited functionality mode responsive to detecting the event, wherein operation of the computer system in the limited functionality mode is reduced compared to operation in a normal mode.

### BRIEF DESCRIPTION OF THE DRAWINGS

The following detailed description makes reference to the accompanying drawings, which are now briefly described.

FIG. 1 is a block diagram of one embodiment of a computer system.

FIG. 2 is a flowchart illustrating one embodiment of computer system initialization.

FIG. 3 is a flowchart illustrating one embodiment of normal operation of the computer system.

FIG. 4 is a flowchart illustrating enforcement of a limited functionality mode.

FIG. 5 is a block diagram illustrating one embodiment of a return to owner service.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF EMBODIMENTS

In one embodiment, a computer system vendor may provide a computer system to a user on a lease/subscription or pay-as-you-go basis. The vendor may require no up-front payment, or a low up-front payment, which may ease the financial burden on the user. In a leasing model, the vendor may require a periodic payment (e.g. monthly), and the user may have full use of the computer system during the calendar time period that has been paid for. In a pay-as-you-go model, the user may purchase system power-on time (e.g. measured in hours), and may use the computer system for the specified number of hours before purchasing additional time. The purchased time may be represented by a card with a magnetic strip or other computer readable media that may be inserted into the computer and read by the computer system. Alternatively, the user may enter a code provided by the vendor, which may be checked against a vendor's data base or may be cryptographically decoded to determine the amount of time provided. The computer system may then meter the available time. In other cases, the time measurement may be made in different ways (e.g. time during which the computer system is active and ready for use, time that the computer system is executing user applications, etc.).

Thus, in general, a user may acquire a use right to the computer system, which permits the user to use the computer system. The use right expires (e.g. according to calendar time, according to time using the computer, number of times using the computer, etc.). When the use right expires, the user must acquire another use right (or renew the use right) in order to continue having full use of the computer system.

In order to enforce the requirement that the user acquire a use right, the computer system may implement one or more modes in addition to the normal mode of operation that is used when the user has an unexpired use right. The first mode is referred to as limited functionality mode herein. In limited functionality mode, one or more components of the computer system are programmed to operate at a reduced level of functionality, as compared to the functionality in normal mode. Thus, the overall functionality of the computer system is reduced, and the user may find the computer to be less useful (or the user may even find the computer system not useful at all).

Because it is possible that a sophisticated user may be able to defeat the security features of the computer system and override the limited functionality mode configuration, another mode may be provided that is reduced as compared to the limited functionality mode. Thus, this second mode may increase the penalty on the user for violating the limited functionality mode configuration. Similarly, the second mode may be entered if any other unauthorized entity attempts to defeat the limited functionality mode by changing the configuration in limited functionality mode (e.g. an individual who has stolen the computer system or has found the computer system after the user lost it, an individual attempting to “hack” into the system, etc.). In one embodiment, the second mode is a zero functionality mode, in which the computer will provide no user functionality at all. The computer system, when powered on, may simply display a message indicating what the user is required to do in order to recover use of the computer system. For example, the message may indicate the location that the user must return the computer system to for reauthorization. Alternatively, it may still be possible to use a card or other medium carrying a new use right to be provided on the computer system, which may permit a return to normal mode. In some embodiments, while the system may provide no user functionality in the zero functionality mode, the system may still provide other functionality. For example, if the user connects the system to the internet or another network, the system may attempt to communicate with the owner to obtain instructions, even though no functionality is being provided to the user.

Accordingly, while in the limited functionality mode, the computer system may monitor the components of the computer system that have been programmed to enter limited functionality mode to ensure that their configuration has not been changed. If a change is detected, the computer system may enter the zero functionality mode. Additionally, in some embodiments, it may be possible to enter the zero functionality mode directly from the normal mode. Such a direct transition to zero functionality mode may be used to enforce other use rights. For example, a use right may permit the use of the computer system in a limited geographical area, and the computer system may enter zero functionality mode if it is moved out of the area. Other events that indicate an intentional violation of any use right may cause a direct transition to the zero functionality mode. The computer system may also detect events that indicate that the computer is lost or stolen, and the computer system may enter zero functionality mode directly from the normal mode if such events are detected.

In addition to the subscription/lease and pay-as-you-go models, the limited functionality mode and zero functionality mode may be used for other purposes. For example, computer systems that are loaned by an owner to a user (e.g. by a company to an employee) may use limited functionality mode if the computer is not at the assigned location (e.g. determinable at a coarse grain level via IP address or at a finer grain level using a global position system or other such geographic locator). The limited functionality mode may be used if a user fails to authenticate to a system (e.g. via password or biometric identification). The zero functionality mode may be used if the computer system is lost or stolen. Another mechanism in which limited functionality mode may be used is for regulatory compliance. For example, if a computer system storing regulated data (e.g. SOX or HIPPA regulated data) is loaned to an employee for home or remote use, the external connections of the computer may be disabled using limited functionality mode so the regulated data cannot be copied, removed, or misused. Alternatively, limited functionality mode may prevent use of the computer system unless it is connected to a particular server, network, or web site. The connection may be made over the internet, or via another connection such as a direct dial-in to the server/network. Such functionality may be useful to an owner who wishes to control the use of the loaned system. The limited functionality mode could display a message to the employee, for example, describing the restriction and the required connection.

Generally, the components of the computer system may comprise any identifiable parts of the system, whether or not those parts are removable from the system. For example, components may include processors, coprocessors, hardware accelerators, memory controllers, bridges from processors to peripheral devices, peripherals devices, etc.

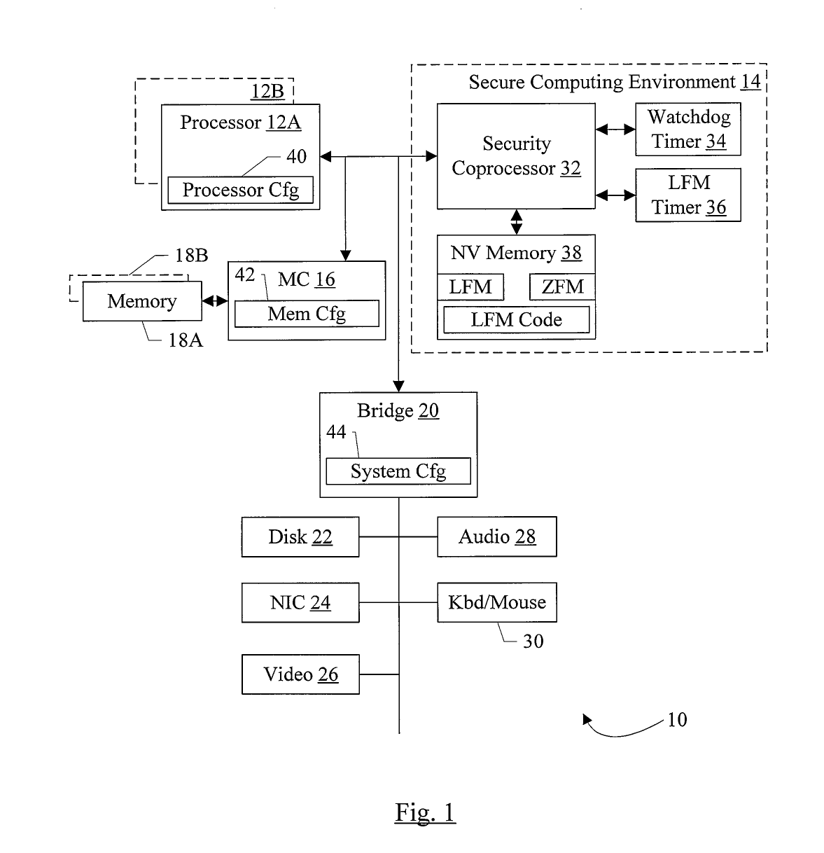

Turning now to FIG. 1, a block diagram is shown illustrating one embodiment of a computer system 10. In the embodiment of FIG. 1, the computer system includes one or more processors such as processors 12A-12B, a secure computing environment 14, a memory controller 16 (which may be one or more than one memory controller, in various embodiments), one or more memory units such as memory units 18A-18B, a bridge 20, one or more peripheral devices such as one or more disk storages 22, one or more network interface controllers (NIC) 24, one or more video controllers 26, one or more audio controllers 28, and one or more keyboard/mouse I/O devices 30. In the illustrated embodiment, the secure computing environment 14 comprises one or more security coprocessors 32, a watchdog timer 34, a limited functionality mode (LFM) timer 36, and a non-volatile (NV) memory 38 storing an LFM indication and a zero functionality mode (ZFM) indication and LFM code executable by the security coprocessor 32. The processor 12A includes one or more processor configuration registers 40. Similarly, the memory controller 16 includes one or more memory configuration registers 42 and the bridge 20 includes one or more system configuration registers 44. Each of the peripheral devices 22, 24, 26, 28, and 30 may include programmable configuration as well.

The security coprocessor 32 is coupled to the NV memory 38, the timers 34 and 36, the processors 12A-12B, the memory controller 16, and the bridge 20. The processors 12A-12B are also coupled to the memory controller 15 and the bridge 20. The memory controller 16 is coupled to the memory devices 18A-18B. The bridge 20 is coupled to the peripheral devices 22, 24, 26, 28, and 30.

The secure computing environment 14 may generally comprise any mechanism for securely executing code. The secure computing environment comprises at least one of: a computer accessible storage medium storing known-good code that is provided by an authenticated source and is protected against unauthorized modification, where the code implements the limited functionality mode described herein; or circuitry that implements the limited functionality mode and that is protected from unauthorized access. In the illustrated embodiment, the secure computing environment 14 comprises the NV Memory 38 that stores the LFM code. Only the security processor 14 (which is within the secure computing environment 14) may access and execute the LFM code, so it is protected from unauthorized access and modification. Thus, the NV Memory 38 may be a source of known-good code. In other embodiments, the known-good code may be executed on the processors 12A-12B, and thus the source of known-good code may be provided in a memory that is protected and with a channel that is protected to the processors 12A-12B. Other embodiments may implement the secure computing environment 14 through system management mode (SMM) code, or using virtual machines, etc.

In this embodiment, the security coprocessor 32 is configured to execute the LFM code and to update the LFM and ZFM indications in the NV memory 38 to reflect whether or not the computer system 10 is in limited functionality mode, zero functionality mode, or normal mode. For example, the LFM and ZFM indications may each be a bit indicative, when set, that the computer system 10 is in the corresponding mode and indicative, when clear, that the computer system 10 is not in the corresponding mode. In such an implementation, normal mode is indicated by the LFM and ZFM bits being clear; limited functionality mode is indicated by the LFM bit being set and the ZFM bit being clear; and zero functionality mode is indicated by the ZFM bit being set and the LFM bit being clear (or the LFM bit may be a don't care). Other embodiments may reverse the set and clear meanings of the bits, or use other encodings. For example, a single mode value may be maintained that includes encodings for normal mode, limited functionality mode, and zero functionality mode. The LFM code may also program the one or more components in the limited functionality mode and/or zero functionality mode (e.g. programming one of the configuration registers 40, 42, and 44 and/or any other device configuration). In embodiments in which there is only one reduced functionality mode (e.g. LFM or ZFM), there may be only one bit that indicates normal mode or the reduced functionality mode.

Additionally, the secure computing environment 14 includes the watchdog timer 34 and the LFM timer 36. The watchdog timer 34 may be used to cause the security processor 32 to periodically (at the expiration of the timer 34) check that the system configuration that was programmed into the system 10 to enter limited functionality mode has not been violated. The LFM timer 36 may be loaded with a value that indicates the use right, and more particularly indicates when the use right has expired. The LFM timer 36 may be used to cause an entry into limited functionality mode. Both timers 34 and 36 are implemented within the secure computing environment (e.g. accessible only to the security coprocessor 32) and thus are secured from unauthorized access. Other embodiments may use other mechanisms than the timers 34 and 36. For example, the timers may be implemented in software, with the current values of the timers stored in the NV memory 38 and the updates made by software executing on the security coprocessor 32.

The computer system 10 is broadly exemplary of a variety of computer systems. A computer system may comprise any device that includes at least one processor configured to execute general purpose instruction code, along with various other devices that may be desirable in a given computer. Computer systems may include personal computers, workstations, laptop or other portable computers, personal digital assistants, smart phones, etc.

For example, the connection between the security coprocessor 32, the processors 12A-12B, the memory controller 16, and the bridge 20 may generally be illustrative of any interconnect or combination of two or more interconnects between the components. Similarly, as mentioned below, the interconnect from the bridge to the peripheral devices 22, 24, 26, 28, and 30 may be one or more interconnects as discussed below.

While the secure computing environment 14 is shown coupled to the processors 12A-12B in FIG. 1, the secure computing environment 14 may be located anywhere within the computer system 10. For example, the secure computing environment 14 may be coupled through a peripheral interface to the bridge 20 (or a private interface to the bridge 20). Alternatively, the secure computing environment 14 may be included in the bridge 20 itself The secure computing environment 14 may comprise one or more integrated circuits coupled to the processor 12A-12B (implemented as one or more separate integrated circuits). The secure computing environment 14 may comprise one or more integrated circuits in a multi-chip module with the processor integrated circuits. In another implementation, at least a portion of the secure computing environment 14 may be integrated onto the same integrated circuit as the processors 12A-12B, or all of the secure computing environment 14 may be integrated with the processors 12A-12B.

Generally, the processors 12A-12B, the memory controller 16, the bridge 20, and the peripheral devices 22, 24, 26, 28, and 30 may all be examples of components. At least some of the components may be programmed by the secure computing environment 14 to cause the computer system 10 to enter limited functionality mode.

There are many variations of programming one or more components to enter limited functionality mode. A non-exhaustive list of possibilities, one or more of which may be used in any combination, include: programming the memory controller to limit the size of the memory to a minimal amount (e.g. sufficient storage for LFM code use, but not more); programming components to force the most significant address bits to zero, limiting the addressable memory space; disabling processors if more than one processor is included; disabling coprocessors, hardware accelerators, graphics processors, network offload engines, and other performance-enhancing assist circuits; disabling external interrupts and debug functionality; disabling processor and system caches; reducing the processor's operating frequency; reducing other operating frequencies (e.g. memory, peripheral interfaces, internal interfaces); reducing a size of the internal interfaces that have configurable widths (e.g. HyperTransport™ (HT)); reducing the video display mode to a lowest possible resolution, or text only; programming the NIC(s) 24 to limit network connectivity to only sites that are authorized by the owner of the computer system; and disabling one or more peripheral devices (e.g. all devices except video, keyboard, and mouse).

The processor or processors 12A-12B may comprise any general purpose processor implementing any instruction set architecture. For example, instruction set architectures include the x86 instruction set architecture (also referred to as Intel Architecture-32 (IA-32), including various extensions such as the AMD 64™ architecture), IA-64, Power PC, ARM, SPARC, etc. A processor may comprise a single microprocessor on its own integrated circuit chip, or may comprise one or more processor cores integrated with other computer components such as the bridge 20, memory controller 16, or components of the secure computing environment 14. The processor configuration registers 40 may store a variety of configuration information (e.g. selected operating frequency, address size, operating modes including privilege level and address translation, power management modes, etc.).

The memory controller 16 is configured to provide an interface to the memory devices 18A-18B. The memory controller 16 may decode the address and select the memory locations mapped to that address. The memory configuration register 42 may store memory size data, the address mapping to memory devices 18A-18B, and various other configuration. There may be one memory controller 16, or there may be multiple memory controllers in a distributed memory system configuration. In one embodiment, the processors 12A-12B may be integrated with memory controller and HT interfaces. Each set of one or more processors and one or more memory controllers may form a node, and multiple nodes may form a distributed coherent memory system using HT links between the nodes. The memory devices 18A-18B may be any type of memory (e.g. DRAM, SDRAM, DDR2 SDRAM, DDR3 SDRAM, etc.). The memory devices 18A-18B may have any construction, including modular arrangements (e.g. single inline memory modules (SIMMs), dual inline memory modules (DIMMs), etc.).

The bridge 20 is a interface between the processors and memory controller and one or more peripheral interfaces to which devices may be coupled. Supported peripheral interfaces may include peripheral component interconnect (PCI), universal serial bus (USB), PCI express (PCIe), PCI-X, microchannel, SCSI, ATA, IDE, etc. Any set of one or more interfaces may be supported, and devices may be coupled to any desired interface. Two or more bridges may also be cascaded (e.g. the north bridge/south bridge configuration used in PCs). The bridge 20 may also include various system wide configurations in the system configuration registers 44 (e.g. configured widths of variable width interfaces, operating frequencies of interfaces, which interfaces are enabled, etc.).

The disk 22 is exemplary of any non-volatile computer accessible storage medium. For example, the disk 22 may comprise hard disk drives such as integrated device electronics (IDE) drives (e.g. parallel or serial advanced technology attachment (ATA)) or small computer system interface (SCSI) drives. The disk 22 may comprise removable disk media or tape media. The disk 22 may comprise optical media such as compact disk (CD) or digital video disk (DVD) technology. The disk 22 may include solid state media such as flash memory.

Generally speaking, a computer accessible storage medium may include any storage media accessible by a computer during use to provide instructions and/or data to the computer. For example, a computer accessible storage medium may include storage media such as magnetic or optical media, e.g., disk (fixed or removable), tape, compact disk read only memory (CD-ROM), or digital video disk ROM (DVD-ROM), CD-R, CD-RW, DVD-R, or DVD-RW. Storage media may further include volatile memory media such as RAM (e.g. synchronous dynamic RAM (SDRAM), Rambus DRAM (RDRAM), static RAM (SRAM), etc.), non-volatile memory media (e.g. ROM, Flash memory, etc.), and media accessible via a peripheral interface such as the Universal Serial Bus (USB) interface, etc. Storage media may include microelectromechanical systems (MEMS), as well as storage media accessible via a communication medium such as a network and/or a wireless link. A carrier medium may comprise a computer accessible storage medium and/or electrical or optical signals on a wireless or wired medium.

The NIC 24 may comprise any interface to a network. For example, the NIC 24 may interface to an Ethernet interface (e.g. 10 Base T, 100 Base T, 1000 Base T, etc.). The NIC 24 may interface to a token ring network, or any other network such as optical networks. The NIC 24 may also comprise a modem for a telephone line, a digital subscriber line modem, a cable modem, etc. The NIC 24 may be an adapter card, or may be integrated onto the main circuit board of the computer system 10. The NIC 24 may be implemented in software, with hardware circuitry to drive the interface.

The video controller 26 may comprise any video display driver, and may also include graphics processing functionality such as rendering. The video controller 26 may be configured to drive any type of display or displays (e.g. cathode ray tube (CRT), liquid crystal display (LCD), thin film transistor (TFT) display, plasma display, etc.).

The audio controller 28 may be any audio output device, capable of driving any audio output (e.g. speakers, or audio connectors that can be connected by cables to other devices such as an entertainment center). The audio controller 28 may be capable of various audio processing as well. The keyboard/mouse 30 may comprise any user input/output devices, including keyboards, mice, other pointing devices such as trackballs, etc.

The peripheral devices 22, 24, 26, 28, and 30 are merely exemplary. Any subset of the devices may be included in various embodiments, as well as any combination of the devices (or a subset thereof) and other peripheral devices may be used. Generally, a peripheral device may include any device that performs one or more operations other than general purpose instruction execution as performed by the processors (e.g. storage, input/output, multimedia communication, networking, data acquisition, etc.).

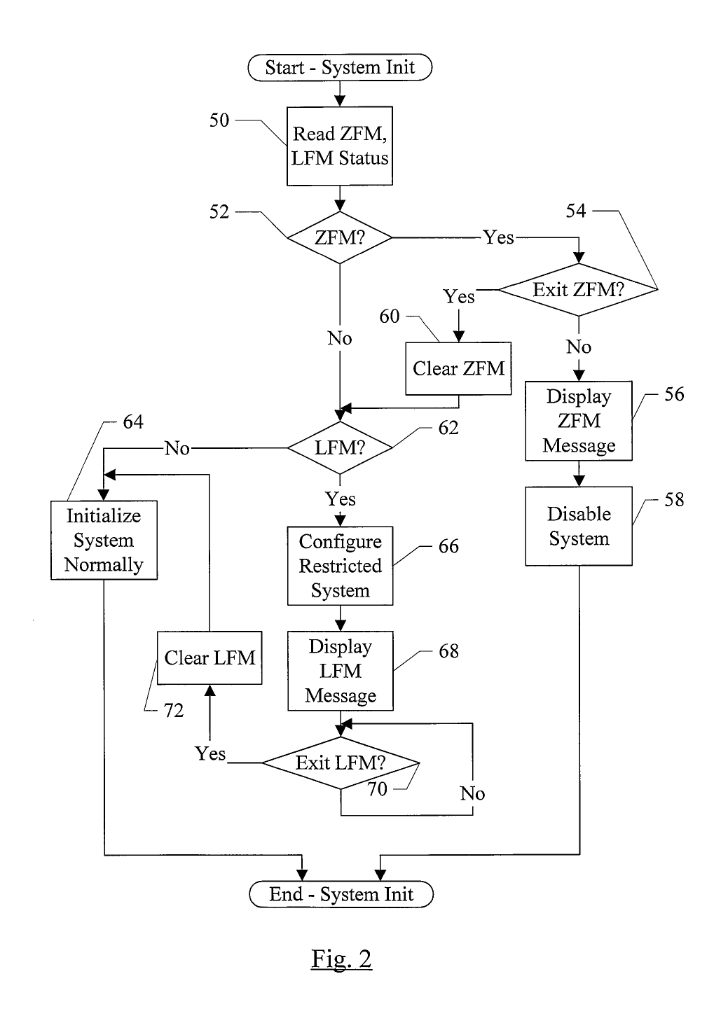

Turning now to FIG. 2, a flowchart is shown illustrating one embodiment of initializing the computer system 10. The operation of the flowchart of FIG. 2 may be performed when the computer system 10 is first powered up, as part of the power on reset initialization. The operation may also be performed after any other reset as well (e.g. a soft reset that may be performed while the computer remains powered on). In the embodiment of FIG. 1, the LFM code may include instructions which, when executed, implement the operation of the flowchart shown in FIG. 2. In other embodiments, the flowchart may be implemented in hardware, or a combination of hardware and software. While the blocks are shown in a particular order in FIG. 2, other orders may be used.

The LFM code may read the ZFM and LFM indications from the NV memory 38 (block 50). If the ZFM indication indicates that the computer system 10 is in zero functionality mode (decision block 52, “yes” leg), and there is no exit from zero functionality mode detected (decision block 54, “no” leg), the LFM code may display a message on the video screen of the computer system 10 that is associated with zero functionality mode, and may disable the computer system 10, preventing any further operation (blocks 56 and 58). Alternatively, no message may be displayed and the computer system 10 may be disabled, appearing inoperative to the user.

Zero functionality mode may be exited (decision block 54) in a variety of fashions, in various embodiments. For example, a storage device containing a unique reauthorization key for the computer system 10 may be retained by the owner. The LFM code may check for the storage device (e.g. a solid state storage device connectable via an I/O port such as the USB port) containing the code. If the code is found, zero functionality mode may be exited. In other embodiments, it may be necessary to return the computer system 10 to the owner to exit zero functionality mode. Other mechanisms for exiting zero functionality mode are possible as well.

The message displayed in zero functionality mode may give the user instructions for how to cause zero functionality mode to exit. For example, the message may instruct the user to return the computer system to the owner. Alternatively, the message may indicate that a reauthorization code must be obtained by contacting the owner, and may provide a mechanism to enter the reauthorization code. In either case, contact information for the owner may be provided.

If zero functionality mode is being exited (decision block 54, “yes” leg), the LFM code may clear the ZFM indication to indicate that zero functionality mode is no longer in force (block 60), and the LFM code may check the LFM indication (decision block 62). Similarly, if the zero functionality mode is not in force (decision block 52, “no” leg), the LFM code may check the LFM indication (decision block 62). If the LFM indication indicates the limited functionality mode is not in force (decision block 62, “no” leg), the LFM code may initialize the computer system 10 normally (block 64). Alternatively, the LFM code may exit (decision block 70) and permit system code (e.g. basic input/output system (BIOS) code) to initialize the computer system 10.

If the LFM indication indicates that the limited functionality mode is in force (decision block 62, “yes” leg), the LFM code may program one or more components of the computer system 10 to configure a restricted system (block 66). Additionally, the LFM code may display a message for the user that is associated with limited functionality mode (block 68). If the user takes action that permits an exit of limited functionality mode (decision block 70, “yes” leg), the LFM code may clear the LFM indication in the NV memory 38 (block 72) and initialize the system normally (block 64).

The mechanisms for exiting limited functionality mode may vary from embodiment to embodiment. For example, any of the mechanisms listed above for exiting zero functionality mode may be used. Additionally, the insertion of a card or other media containing a use right may cause an exit of LFM. A use right may be downloaded from a server owned by the owner to exit LFM. For example, the NIC may be restricted to connecting only with computer systems owned by the owner when in limited functionality mode. The computer systems owned by the owner may receive a payment from the user and may provide a use right in response over the network.

It is noted that, in addition to awaiting an exit condition, various other operations may be performed in limited functionality mode. Similarly, various other operations may be performed in zero functionality mode. For example, if the computer system 10 includes a camera, the camera may periodically take pictures. The pictures may be stored on the disk drive and/or may be transmitted to the owner if an internet connection or other network connection is available or becomes available. Similarly, if the computer system includes a microphone, sound could periodically be recorded and transmitted. Such data may be useful in locating a lost or stolen computer system, for example. The computer system 10 may play audio messages or make siren sounds to alert those nearby to a stolen computer system. All key strokes on the keyboard may be logged. If a network connection is available, the computer system 10 may automatically attempt contact the owner or an associated entity, may provide control of the computer system to the remote owner (e.g. permitting the owner to erase data on the computer system or otherwise render the computer system inoperable), and may send various data.

It is noted that, while the flowchart of FIG. 2 supports both LFM and ZFM, other embodiments may support only one reduced functionality mode. Such embodiments may implement the ZFM portion of the flowchart, or the LFM portion, depending on which mode is implemented.

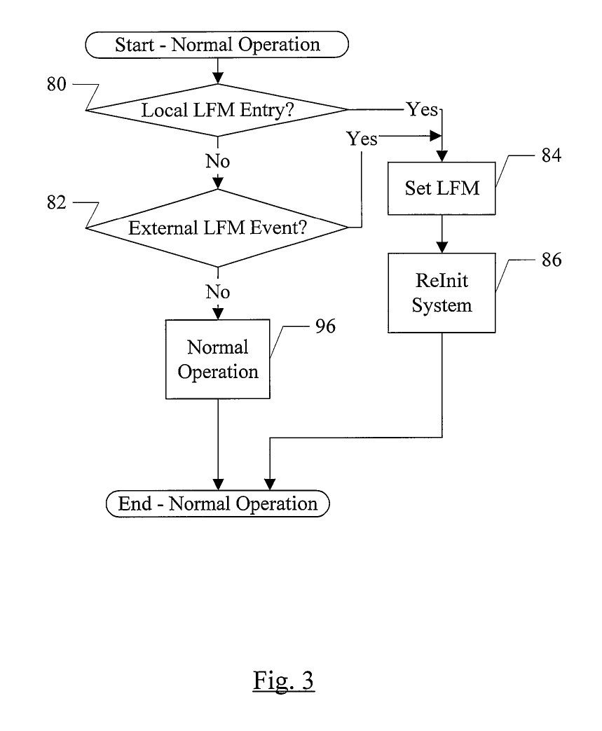

Turning now to FIG. 3, a flowchart is shown illustrating one embodiment of the computer system 10 during “normal” operation (that is, operation when an unexpired use right is in place). The operation of the flowchart of FIG. 3 may be performed periodically in normal operation, or in response to an input that may effect limited functionality mode (either external or from the LFM timer 36). In the embodiment of FIG. 1, the LFM code may include instructions which, when executed, implement the operation of the flowchart shown in FIG. 3. In other embodiments, the flowchart may be implemented in hardware, or a combination of hardware and software. While the blocks are shown in a particular order in FIG. 3, other orders may be used.

The LFM code may determine if a local entry to limited functionality mode is detected (decision block 80, “yes” leg) or an external event is detected that causes an entry to the limited functionality mode is detected (decision block 82, “yes” leg). If either is detected, the LFM code may set the LFM indication in the NV memory 38 (block 84) and may cause a reinitialization of the computer system 10 (block 86). For example, a soft reset may be signaled to cause the flowchart of FIG. 2 to be performed. Since the LFM indication is set to indicate limited functionality mode, the flowchart of FIG. 2 results in the computer system 10 entering the limited functionality mode. If no local entry to the limited functionality mode is detected and no external event that would cause such a transition is detected (decision blocks 80 and 82, “no” legs), the computer system 10 continues in normal operation (block 96).

Local entry to the limited functionality mode is detected if the use right currently in the secure computing environment expires. There may be other local entry detection scenarios as well. For example, detecting attempts to hack the computer system may lead to entry into limited functionality mode. Attempting to connect to an unauthorized internet service provider (ISP) may cause entry to LFM. External events that cause entry to limited functionality mode may include, for example, receiving a command from the owner (e.g. over a network such as the internet) indicating that limited functionality mode should be entered; a failure to authenticate the user (e.g. via password or biometric identification of the user); and a change in geographic location of the computer system (detected via a global position system, for example). Similarly, zero functionality mode may be entered for any of the above events. In one embodiment, if the computer system is returned to a geographic location that is acceptable to the owner, the computer system may exit limited functionality mode.

It is noted that, in some embodiments, the LFM code may be configured to provide warnings to the user if a use right is about to expire, in addition to the operation shown in FIG. 3. The warnings may permit the user to acquire a new use right before the current use right expires. In other embodiments, there may be instances in which the computer system 10 transitions from the normal mode directly to zero functionality mode (or there may be only one reduced functionality mode). In such embodiments, the LFM code may also detect the direct transitions and set the ZFM indication in a manner similar to that described above for the LFM indication.

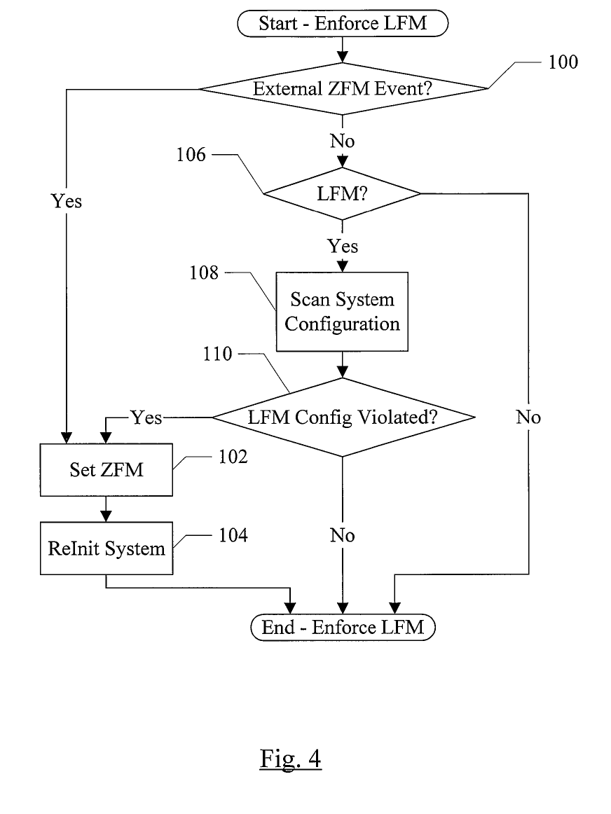

Turning now to FIG. 4, a flowchart is shown illustrating one embodiment of the computer system 10 to enforce limited functionality mode. The operation of the flowchart of FIG. 4 may be performed periodically (e.g. at the expiration of the watchdog timer 34) to monitor the components of the computer system 10 to ensure that the limited functionality mode configuration has not been violated (e.g. changed by the user defeating the secure computing environment's protections or otherwise overriding the operation of the secure computing environment 14). In the embodiment of FIG. 1, the LFM code may include instructions which, when executed, implement the operation of the flowchart shown in FIG. 4. In other embodiments, the flowchart may be implemented in hardware, or a combination of hardware and software. While the blocks are shown in a particular order in FIG. 4, other orders may be used.

The LFM code may determine if an external event has been detected that would cause an entry to zero functionality mode (decision block 100). For example, receiving a command to enter zero functionality mode over a network from the owner may be such an external event (or receiving a command indicating that the computer system 10 has been lost or stolen); detecting a change in geographic location may be such an external event; etc. If an external event causing entry to zero functionality mode is detected (decision block 100, “yes” leg), the LFM code may set the ZFM indication in the NV memory 38 (block 102) and may reinitialize the system (causing the flowchart of FIG. 2 to be performed and thus causing the computer system to entry zero functionality mode—block 104).

The LFM code may read the LFM indication, and if the computer system 10 is in limited functionality mode (decision block 106, “yes” leg), the LFM code may scan the computer system 10 configuration and examine components to ensure that the computer system 10 is still in the limited functionality mode (block 108). If the limited functionality mode configuration has been violated (decision block 110, “yes” leg), the LFM code may set the ZFM indication in the NV memory 38 (block 102) and may reinitialize the system (causing the flowchart of FIG. 2 to be performed and thus causing the computer system to enter zero functionality mode—block 104).

It is noted that, while the above description refers to reinitializing the computer system 10 when entering or exiting limited functionality mode and/or zero functionality mode, other embodiments need not reinitialize the system. Rather, the components may be programmable to implement limited functionality mode without reinitialization.

While the present embodiment includes limited functionality mode and zero functionality mode, other embodiments may include additional modes. For example, there may be several levels of limited functionality modes, each having a different level of functionality. The secure computing environment may progressively reduce the functionality over time by changing which limited functionality mode is active. That is, the longer that the user waits to resubscribe or purchase additional pay-as-you-go time, the less functionality the user will have on the computer system.

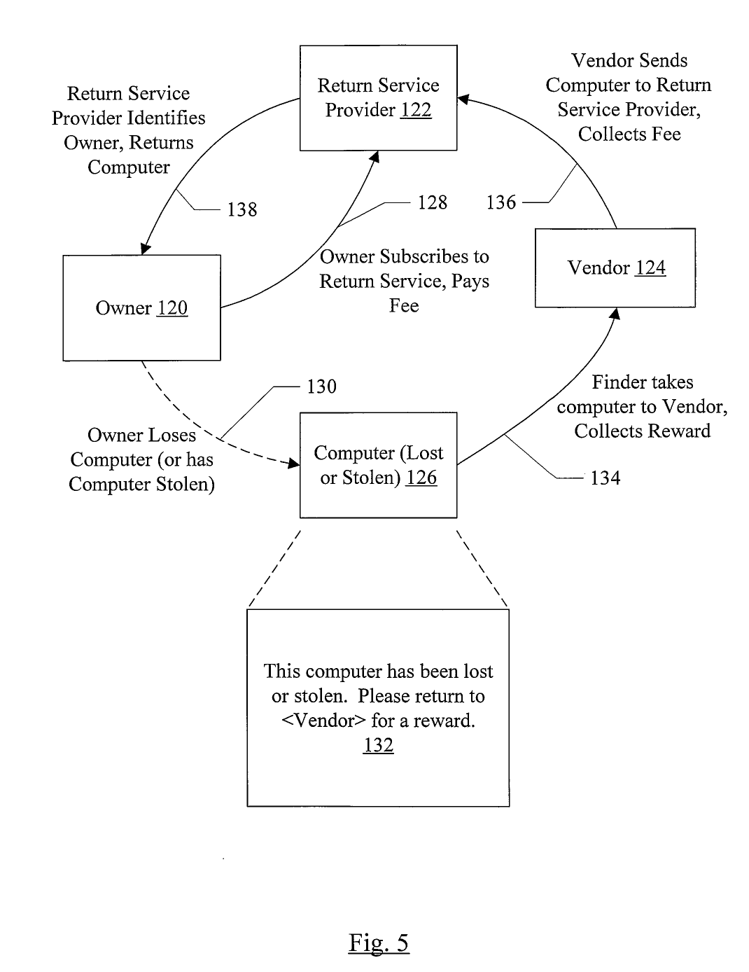

In addition to the above uses of limited functionality mode and zero functionality mode for leased and pay-as-you-go models for computer systems, other uses are also possible. For example, FIG. 5 illustrates a mechanism for returning a lost or stolen computer system to an owner 120 who has contracted with a return service provider 122 to return such a computer system. The return service provider 122 may contract with a vendor 124 that is easily reachable by an individual who finds a lost/stolen computer (e.g. a nationwide electronics chain such as Best Buy, Fry's Electronics, etc.).

The mechanism may operate as follows. The owner 120 may have a computer system 126 that the owner 120 registers with the return service provider 122. The owner may subscribe to the return service, paying a fee for the service (arrow 128). The fee may be a one-time fee, or a periodic service fee (e.g. charged monthly). The computer system 126 may have a unique identifier such as a serial number or other identifier that can be used to identify the computer system 126. If the owner 120 loses the computer system 126 (or it is stolen—dotted arrow 130), the computer system 126 may enter limited functionality mode or zero functionality mode. The message displayed by the computer system (reference numeral 132) may indicate that the computer has been lost or stolen and may direct the finder to return the computer system to the vendor 124 to receive a reward. In the case that the vendor 124 has more than one location (e.g. a nationwide chain), the message may indicate that the finder should return the computer system 126 to the nearest vendor location. Alternatively, if the computer system 126 has GPS or other geographic location technology, the computer system 126 may provide the address of the nearest vendor location.

Incentivized by the reward and the fact that the computer system 126 only operates in limited or zero functionality mode, the finder returns the computer system 126 to the vendor 124, collecting the reward (arrow 134). The reward may be a cash reward, a gift card for use in purchases made by the finder at the vendor 124, or an item normally sold by the vendor 124, for example.

The vendor 124 may ship the computer system 126 to the return service provider 122, and may collect a fee for its return (arrow 136). Using the identifier that was registered by the owner 120 when the owner subscribed, the return service provider 122 may identify the owner 120 and return the computer system 126 to the owner (arrow 138).

Numerous variations and modifications will become apparent to those skilled in the art once the above disclosure is fully appreciated. It is intended that the following claims be interpreted to embrace all such variations and modifications.

What is claimed is:

1. A computer system comprising:
one or more components; and
a secure computing environment coupled to the components and configured to program at least one of the components to enter a limited functionality mode responsive to expiration of a use right to the computer system, wherein operation of the computer system in the limited functionality mode is reduced compared to operation when the use right has not expired, and wherein the secure computing environment is configured to monitor the components in the limited functionality mode to detect that a limited functionality mode configuration has been modified by an unauthorized entity, and wherein the secure computing environment is configured to cause the computer system to enter a second mode in which operation of the computer system is reduced compared to operation in the limited functionality mode in response to detecting that the limited functionality mode configuration has been modified.

2. The computer system as recited in claim 1 wherein the second mode comprises a mode in which the computer system does not provide any user operation.

3. The computer system as recited in claim 2 wherein, in the second mode, the secure computing environment is configured to display a message for a user, wherein the message explains a corrective measure to be taken by the user.

4. The computer system as recited in claim 1 wherein the secure computing environment is further configured to program the component to enter the limited functionality mode responsive to an external event.

5. The computer system as recited in claim 4 wherein the external event is a command received from another computer system owned by an owner of the computer system.

6. The computer system as recited in claim 4 wherein the external event is a change in geographic location of the computer system.

7. The computer system as recited in claim 4 wherein the external event is a failure to identify an authorized user.

8. The computer system as recited in claim 1 wherein the secure computing environment is further configured to program the component to enter the second mode responsive to an external event.

9. A method comprising:
programming at least one of one or more components in a computer system to enter a limited functionality mode responsive to expiration of a use right to the computer system, wherein operation of the computer system in the limited functionality mode is reduced compared to operation when the use right has not expired;
monitoring the components in the limited functionality mode to detect that a limited functionality mode configuration has been modified by an unauthorized entity; and
entering a second mode in which operation of the computer system is reduced compared to operation in the limited functionality mode in response to detecting that the limited functionality mode configuration has been modified.

10. The method as recited in claim 9 wherein the second mode comprises a mode in which the computer system does not provide any user operation.

11. The method as recited in claim 10 further comprising, in the second mode, displaying a message for an individual who finds the computer system, wherein the message directs the individual to return the computer system to a specified vendor location.

12. The method as recited in claim 11 further comprising providing the individual with a reward for returning the computer system to the specified vendor location.

13. The method as recited in claim 11 further comprising returning the computer system to a return service provider from the vendor location, wherein the return service provider provides a return service to which an owner of the computer system subscribes.

14. The method as recited in claim 13 further comprising returning the computer system from the return service provider to the owner.

15. The method as recited in claim 9 further comprising programming the at least one component to enter the limited functionality mode responsive to an external event.

16. The method as recited in claim 9 further comprising entering the second mode responsive to an external event.

17. A computer accessible storage medium storing a plurality of instructions which, when executed, implement the method as recited in claim 9

18. A computer system comprising:
one or more components; and
a secure computing environment coupled to the components and configured to detect a non-temporal event that indicates a violation of a restriction imposed by an owner of the computer system, and wherein the secure computing environment is configured to program at least one of the components to enter a limited functionality mode responsive to detecting the event, wherein operation of the computer system in the limited functionality mode is reduced compared to operation in a normal mode.

19. The computer system as recited in claim 18 wherein the event comprises a change in geographic location.
